(19) United States
(12) Patent Application Publication
(10) Pub. No.: US 2009/0028981 A1
(43) Pub. Date: Jan. 29, 2009

(54) HONEYCOMB STRUCTURE BODY MOLDING DIE

(75) Inventor: Tadanobu Asaoka, Takahama-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/173,133

(22) Filed: Jul. 15, 2008

(30) Foreign Application Priority Data
Jul. 24, 2007 (JP) 2007-191781

(51) Int. Cl. B29C 47/20

(52) U.S. Cl. 425/461

(57) ABSTRACT

A honeycomb structure body molding die for molding a honeycomb structure body having cells walls, a large number of cells surrounded with the cells walls, and a cylindrical outer circumferential skin is disclosed as including a die main body having material feed bores and slit recesses, and a guide ring. The guide ring has a guide section having an opposing guide surface, facing a slit recess forming surface of the die main body, which has an annular circumferential area formed with a pool recess, concaved from the opposing guide surface in an extruding direction, which is formed with a slanted surface tapered at an inclining angle β satisfying the relationship expressed as 10°—β≦20° so as to decrease in depth as an inner radial end of the pool recess slanted surface approaches the guide end of the guide section.

### CROSS REFERENCE TO RELATED APPLICATIONS

This application is related to Japanese Patent Application No. 2007-191781, filed on Jul. 24, 2007, the content of which is hereby incorporated by reference.

### BACKGROUND OF THE INVENTION

1. Technical Field of the Invention

The present invention relates to a honeycomb structure body molding die for extrusion molding a honeycomb structure body.

2. Description of the Related Art

There has been known a honeycomb structure body 8 (see FIG. 7) as a catalyst carrier for carrying a catalyst that purifies exhaust gases emitted from an internal combustion engine of an automotive vehicle or the like. The honeycomb structure body 8 had, for instance, honeycomb-shaped cell walls 81, a large number of cells 82 surrounded with the cell walls 81, and a cylindrical outer circumferential skin 83 covering an outer circumferential sidewall.

In general practice, the honeycomb structure body 8 had been manufactured by extrusion molding a material including a ceramic raw material upon using a honeycomb structure body molding die.

Various attempts have heretofore been made in the related art to provide honeycomb structure body molding dies in various structures as disclosed in Japanese Patent Application Publication 2002-283326.

As shown in FIG. 11, for instance, the honeycomb structure body molding die 91 has a die main body 92, including material feed bores 931, through which the molding material 80 is fed, and lattice-shaped slit recesses 941 for squeezing a molding material for extrusion molding a honeycomb structure body, and a guide ring 95. The guide ring 95 guides the molding material 80, squeezed from the slit recesses 941, to obtain a desired outer profile.

When extrusion molding the molding material 80 upon using the honeycomb structure body molding die 91 of the structure described above, as shown in FIG. 11, the molding material 80 is axially squeezed from the slit recesses 941 axially facing the guide ring 95 to flow into a clearance 910 between the die main body 92 and the guide ring 95. Then, the molding material 80 flows through the clearance 910 in a direction toward the center of the die main body 92. At a radially inward guide end 951 of the guide ring 95, the stepped section 942 restricts the molding material 80 from further moving intact toward the center of the die main body 92. During such inward movement of the molding material 80, the guide ring 95 guides the molding material 80 to turn in the extruding direction, thereby forming an outer circumferential skin 83.

As shown in FIG. 11, the molding material 80, forming the outer circumferential skin 83, is squeezed from the slit recesses 941 and immediately caused to flow toward the center of the die main body 92 in a spreading pattern. Such a flow of the molding material 80 resulted in an uneven (nonuniform) flowing condition (involving a flow rate, a flow speed and a flowing direction or the like). Thus, the outer circumferential skin 83 was formed to have a thickness in increased variation and nonuniformity.

### SUMMARY OF THE INVENTION

The present invention has been completed with a view to addressing the above issues and has an object to provide a honeycomb structure body molding die that can manufacture a honeycomb structure body with increased precision having an outer circumferential skin with uniform thickness.

To achieve the above object, an aspect of the present invention provides a honeycomb structure body molding die for molding a honeycomb structure body having honeycomb-shaped cells walls, a large number of cells surrounded with the cells walls, and a cylindrical outer circumferential skin covering an outer circumferential sidewall, wherein the cell walls and the outer circumferential skin are unitarily formed. The honeycomb structure body molding die comprises a die main body having material feed bores, through which a molding material is fed, and lattice-shaped slit recesses formed in communication with the material feed bores, respectively, for forming the molding material into a honeycomb configuration; and a guide ring having an upright support section extending from the die main body in an extruding direction of the molding material, and a guide section protruding inward from the upright support section with a clearance spaced from the die main body. The guide section of the guide ring has an opposing guide surface, facing a slit recess forming surface of the die main body, which has an annular circumferential area formed with a pool recess concaved from the opposing guide surface in the extruding direction. The pool recess has an inner surface formed with a pool recess slanted surface that is tapered with respect to the opposing guide surface at an inclining angle β satisfying the relationship expressed as 10°≦β≦20° so as to decrease in depth as an inner radial end of the pool recess slanted surface approaches the guide end of the guide section.

The honeycomb structure body molding die, implementing the present invention, comprises the die main body, through which the molding material is supplied to the feed bores and squeezed from the slit recesses, and the guide ring that guides the squeezed molding material to obtain a desired outer profile (outer circumferential skin).

The guide section of the guide ring has the annular circumferential area formed with the pool recess formed in the shape concaved from the opposing guide surface, facing the slit recess forming surface of the die main body, in the extruding direction. Therefore, the molding material, squeezed from the die main body into the clearance between the guide ring and the die main body, is caused to flow into the pool recess to be accumulated (pooled) therein once. Thereafter, the molding material is delivered from the pool recess to flow through the clearance between the guide ring and the die main body toward the center of the die main body (hereinafter, suitably referred to as “center direction”). Then, the molding material is guided with the guide section of the guide ring to run in the extruding direction, thereby forming the outer circumferential skin.

That is, the squeezed molding material is accumulated in the pool recess once, after which the molding material is caused to flow to the center of the die main body. This allows the molding material to flow to the center of the die main body under an uniformalized flowing condition (including a flow ate, a flow speed and flowing direction or the like). This minimizes a variation in thickness of the outer circumferential skin during a process of molding the honeycomb structure body. In addition, the outer circumferential skin can be formed with increased moldability and uniformity.

Further, with the honeycomb structure body molding die implementing the present invention, the pool recess has the inner surface formed with the pool recess slanted surface tapered at the inclining angle β satisfying the relationship expressed as 10°≦β≦20° so as to gradually decrease in depth as the inner radial end of the pool recess slanted surface approaches the guide end of the guide section. With the pool recess having the inner surface formed with the pool recess slanted surface tapered at such a specified inclining angle, the pool recess slanted surface gradually pressurizes the molding material during inward movement of the molding material through the clearance toward the center of the die main body. Therefore, the molding material has increased density, under which the molding material is caused to flow toward the center of the die main body. This enables the outer circumferential skin to be formed with increased precision using such a molding material with increased density.

Thus, the honeycomb structure body molding die implementing the present invention enables the outer circumferential skin to be formed in uniform thickness with high precision and a lessened variation.

### BRIEF DESCRIPTION OF THE DRAWINGS

FIG. 1 is a plan view showing a honeycomb structure body molding die of a first embodiment according to the present invention.

FIG. 2 is a cross sectional view taken on line A-A of FIG. 1.

FIG. 3A is an illustrative view showing a die main body, having a slit recess forming surface, which forms part of the honeycomb structure body molding die of the first embodiment shown in FIG. 1;

FIG. 3B is an enlarged view of the slit recess forming surface shown in FIG. 3A.

FIG. 4 is an illustrative view showing a guide section of a guide ring provided in the honeycomb structure body molding die of the first embodiment shown in FIG. 1.

FIGS. 5A to 5D are perspective views showing how the honeycomb structure body molding die of the first embodiment, shown in FIG. 1, is manufactured.

FIG. 6 is a cross sectional view showing how a honeycomb structure body is formed using the molding die of the first embodiment shown in FIG. 1.

FIG. 7 is a perspective view showing the honeycomb structure body extrusion molded with the honeycomb structure body molding die shown in FIG. 6.

FIG. 8 is a cross sectional view showing a honeycomb structure body molding die of a second embodiment according to the present invention.

FIG. 9 is a cross sectional view showing a honeycomb structure body molding die of a third embodiment according to the present invention.

FIG. 10 is a cross sectional view showing how a honeycomb structure body is formed using the molding die of the third embodiment shown in FIG. 9.

FIG. 11 is a cross sectional view showing a honeycomb structure body molding die of the related art and showing how a honeycomb structure body is extrusion molded using the honeycomb structure body molding die of the related art.

### DETAILED DESCRIPTION OF PREFERRED EMBODIMENTS

Now, a honeycomb structure body molding die of one embodiment according to the present invention will be described below in detail with reference to the accompanying drawings. However, the present invention is construed not to be limited to such an embodiment described below and technical concepts of the present invention may be implemented in combination with other known technologies or the other technology having functions equivalent to such known technologies.

In the following description, it is to be understood that such terms as “outer”, “inner”, “center”, “radial”, “inward”, “toward”, “upright”, “extruding”, “opposing”, “circumferential”, “distal”, “end” and the like are words of convenience and are not to be construed as limiting terms.

Further, the term “extruding direction” refers to a direction in which a molding material is squeezed from the die main body.

Furthermore, the term “slit recess forming surface” refers to a surface of the die main body on which the slit recesses are formed.

Moreover, the slit recesses are formed in the latticed structure, which may take various configurations in conformity to the shape of the cell walls of a honeycomb structure body to be molded. Examples of these configurations may include a triangular shape, a squared shape and a hexagonal shape or the like.

In addition, a cross-sectional shape of the pool recess taken in an axial direction may include various shapes. For instance, the cross-sectional shape of the pool recess may take a polygonal shape formed with only straight lines and the other shape including a curved line in part.

Further, if the inclining angle β of the pool recess slanted surface with respect to the opposing guide surface is less than 10°, it is likely that the molding material cannot be adequately pressurized when flowing through the clearance from the pool recess toward the center of the die main body. In contrast, if the inclining angle β exceeds 20°, there is a fear of an increased variation occurring in flowing direction of the molding material when flowing through the clearance from the pool recess toward the center of the die main body. This results in a possible drop in uniformity of the flowing condition of the molding material.

Further, the inner radial end of the pool recess slanted surface may be preferably spaced from the guide end of the guide section on a plane perpendicular to the extruding direction by a distance ranging from 0.5 to 20 mm.

With such a structure, an adequate distance can be ensured for the molding material, accumulated once in the pool recess, to flow into the clearance facing the opposing guide surface upon which the molding material is guided with the guide section to turn in the extruding direction. This enables the molding material to flow toward the center of the die main body in a further homogenized flowing condition (especially the flowing direction).

Furthermore, the slit recess forming surface of the die main body may be preferably formed on a coplanar plane.

In addition, the die main body may preferably comprise a stepped section protruding from the slit recess forming surface in the extruding direction in an area where the stepped section does not oppose the guide section in an axial direction of the die main body. That is, the slit recess forming surface is formed in two stages.

With either one of such structures, the present invention can exhibit an advantageous effect of enabling the formation of the outer circumferential skin with uniform thickness in increased precision.

### First Embodiment

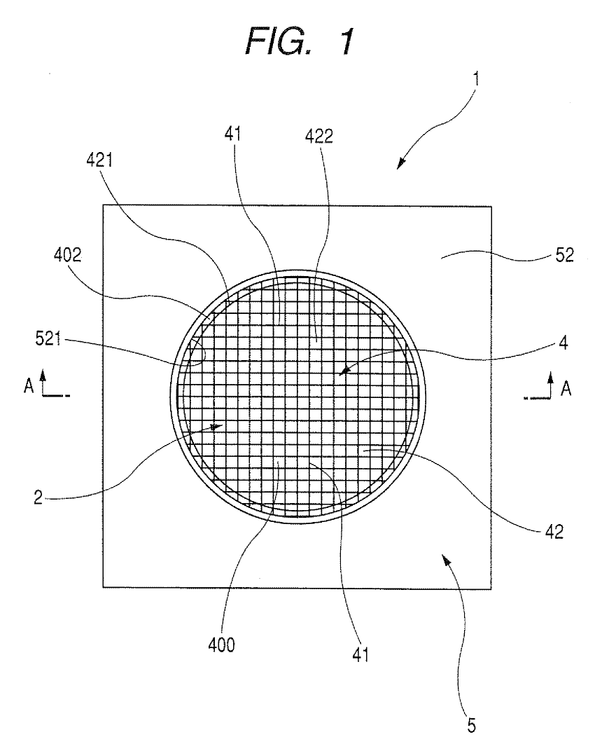

Now, a honeycomb structure body molding die of an embodiment according to the present invention is described below with reference to FIGS. 1 to 4 of the accompanying drawings.

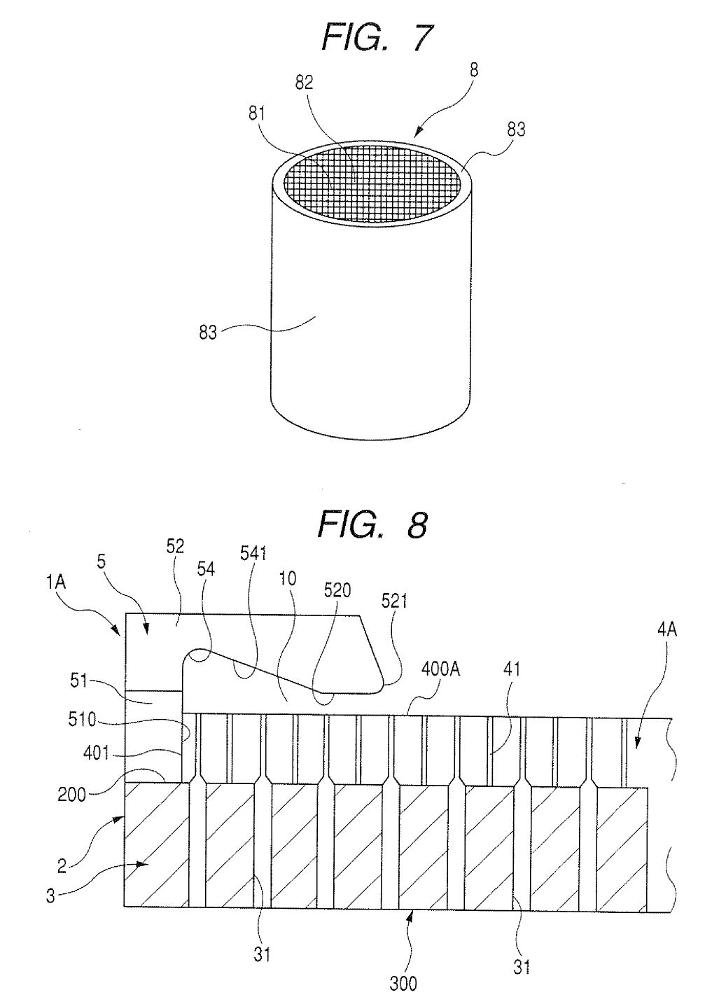

As shown in FIGS. 1 to 4, the honeycomb structure body molding die 1 of the present embodiment serves to mold a honeycomb structure body 8 (see FIG. 7) having honeycomb-shaped cell walls 81, a large number of cells 82 defined with the cell walls 81, and an outer circumferential skin 83 with the cell walls 81 and the outer circumferential skin 83 being unitarily formed in structure.

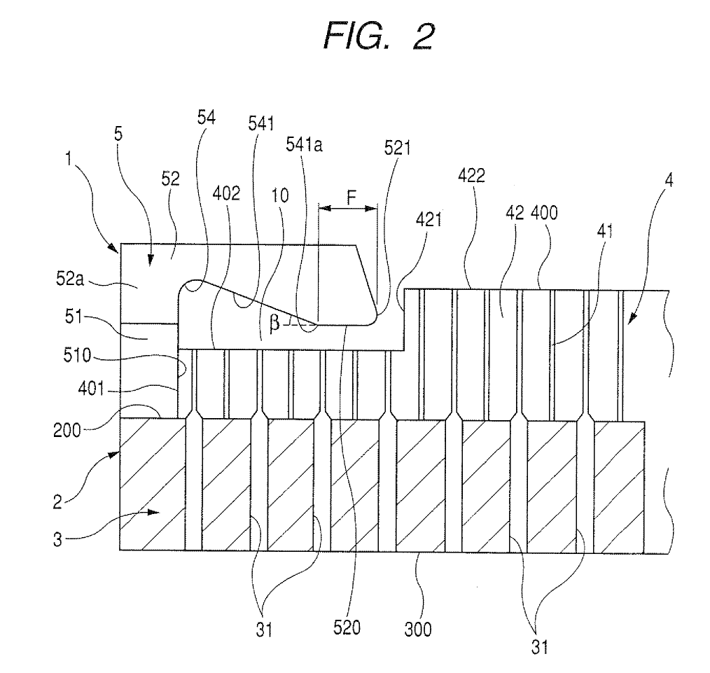

As shown in FIGS. 1 and 2, the honeycomb structure body molding die 1 of the present embodiment is comprised of a die main body 2 and an outer circumferential guide ring 5. The die main body 2 has guide holes (not shown) through which the guide ring 5 is fixedly mounted. Likewise, the guide ring 5 has guide holes (not shown) through which the die main body 2 is fixedly located.

The die main body 2 includes a feed bore section 3 formed with a large number of material feed bores 31 for feeding a molding material therethrough, and a slit recess section 4 having lattice-shaped slit recesses 41 formed in communication with the material feed bores 31, respectively, for shaping the molding material into a honeycomb compact body.

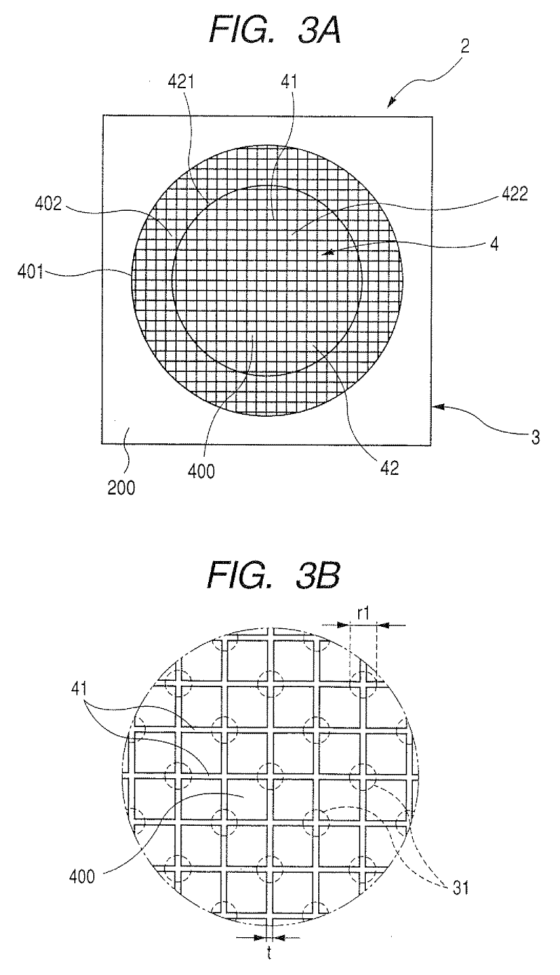

As shown in FIGS. 2 and 3A, the slit recess section 4 has an outer circumferential slit recess forming surface 402, formed in an annular shape, and a circular protruding portion, extending from the outer circumferential slit recess forming surface 402, which has a slit recess forming surface 400 formed with lattice-shaped slit recesses 41. The slit recess forming surface 400 has a central area formed with a circular stepped section 42, protruding in an extruding direction in a position not to axially face the guide ring 5. The slit recess forming surface 400 includes a central slit recess forming surface 422, formed on the stepped section 42, and the outer circumferential slit recess forming surface 402 formed around the stepped section 42.

As shown in FIG. 2, the feed bore section 3 has the material feed bores 31 extending from a feed bore forming surface 300 (on a plane opposite to the slit recess forming surface 400) in the extrusion direction in communication with the slit recesses 41.

Further, as shown in FIG. 3B, the material feed bores 31 are formed in the die main body 2 at lattice positions each corresponding to every other lattice position among lattice points of the lattice-shaped slit recesses 41. Each of the material feed bores 31 has an inner diameter r1 of 1.5 mm and each of the slit recesses 41 has a width “t” of 100 μm.

As shown in FIGS. 1 and 2, the annular guide ring 5 includes an upright support section 51, extending from a reference surface 200 of the die main body 2, and a guide section 52, having an outer circumferential end portion 52a supported with the upright support section 51, which extends radially inward. The guide section 52 is spaced from the outer circumferential slit recess forming surface 402 of the slit recess section 4 to provide a clearance 10.

The upright support section 51 takes the form of a ring shape in structure held in abutting engagement with an outer circumferential sidewall 401 of the slit recess section 4 of the die main body 2. The upright support section 51 is designed to have a height determined to be greater than a height of the outer circumferential slit recess forming surface 402 of the slit recess section 4, thereby ensuring the formation of the clearance 10.

The guide section 52 has an opposing guide surface 520, facing the outer circumferential slit recess forming surface 402 of the slit recess section 4, which extends radially inward so as to maintain the clearance 10 between the outer circumferential slit recess forming surface 402 and the opposing guide surface 520. The guide section 52 has a radially inward guide end 521, placed in a radially inward position, which is formed in a circular configuration in conformity to an outer profile of the honeycomb structure body 8 to be obtained. In addition, the radially inward guide end 521 is radially spaced from an outer circumferential sidewall 421 of the stepped section 42 by a given distance corresponding to a thickness of the outer circumferential skin 83 to be formed.

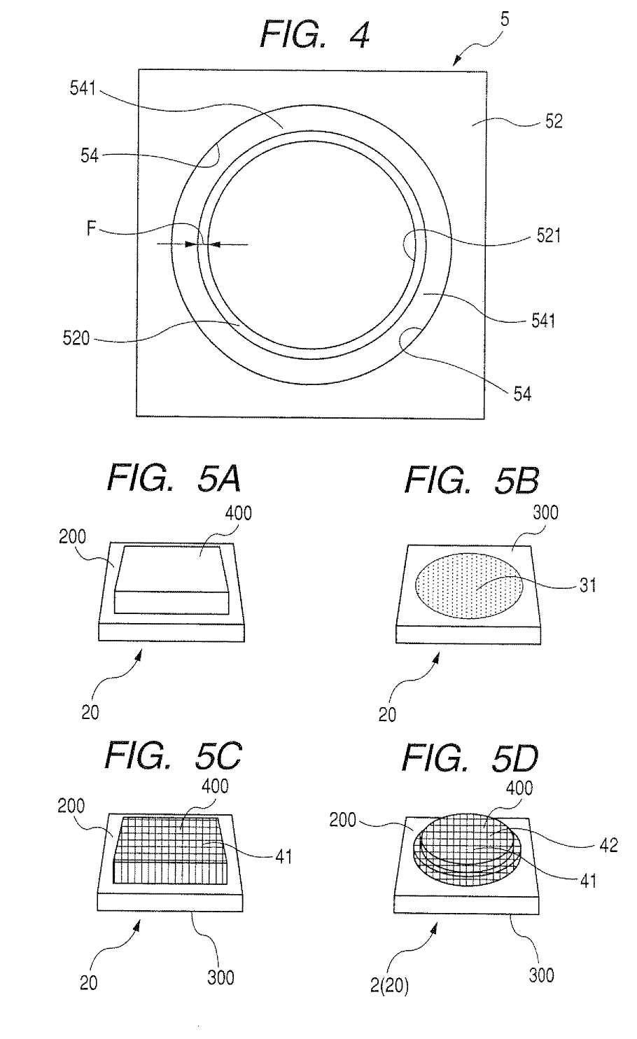

As shown in FIGS. 2 and 4, with the honeycomb structure body molding die 1 of the present embodiment, the guide section 52 of the guide ring 5 has an overall circumferential area formed with an annular pool recess 54 that is concaved from the opposing guide surface 520 in the extruding direction so as to face the outer circumferential slit recess forming surface 402 of the slit recess section 4.

As shown in FIGS. 2 and 4, further, the annular pool recess 54 has an inner circumferential surface formed with a pool recess slanted surface 541 that is tapered so as to decrease in axial depth as one end of the pool recess slanted surface 541 approaches the guide end 521 of the guide section 52. Thus, the pool recess slanted surface 541 is slanted from the opposing guide surface 520 at an inclining angle β satisfying the relationship expressed as 10°≦β≦20°. In the illustrated embodiment, the inclining angle β was set to 15°. In addition, the pool recess slanted surface 541 has an inward circumferential edge 541a spaced from the guide end 521 of the guide section 52 by a distance F of 2.5 mm in a direction perpendicular to the extruding direction of the material.

Next, a method of manufacturing the honeycomb structure body molding die 1 of the present embodiment will be simply described below.

In preparing honeycomb structure body molding die 1 of the present embodiment, first, a square-shaped plate member, made of hot work tool steel (JIS SKD61), is prepared as a die raw material 20.

As shown in FIG. 5A, subsequently, outer-circumference rough machining is conducted to cut an outer circumferential portion of the die raw material 20 so as to form the reference surface 200 and the slit recess forming surface 400 that protrudes from the reference surface 200.

As shown in FIG. 5B, a large number of material feed bores 31 are formed on a rear surface of the raw molding material 20 on a plane opposite to the roughly machined surface thereof and serving as the feed bore forming surface 300 by drilling using a drill.

Then, as shown in FIG. 5C, a large number of slit recesses 41 are formed on the slit recess forming surface 400 of the die raw material 20 one by one in a square-shaped lattice pattern by using a disc-like grinding stone (not shown).

Subsequently, as shown in FIG. 5D, the die raw material 20 is machined to shape an outer circumferential periphery of the slit recess forming surface 400 of the die raw material 20 in a given circular configuration. Then, stepped-profile machining is conducted on the slit recess forming surface 400 of the die raw material 20 to form the outer circumferential slit recess forming surface 402 and the stepped section 42 in a central area of the slit recess forming surface 400 so as to protrude from the outer circumferential slit recess forming surface 402, thereby obtaining the die main body 2.

Next, the guide ring 3 is assembled onto the resulting die main body 2. In fixedly mounting the guide ring 3 onto the resulting die main body 2, the guide ring 5 is placed on the reference surface 200 of the die main body 2 by using plural fixing pins (not shown) embedded into the pin holes of the die main body 2 and the pin holes of the guide ring 5. During such placement, an inner circumferential surface 510 of the upright support section 51 of the guide ring 5 is brought into abutting engagement with the outer circumferential sidewall 401 of the slit recess section 4 of the die main body 2.

With the steps conducted in such a way mentioned above, the honeycomb structure body molding die 1 is obtained.

Now, a method of manufacturing the honeycomb structure body 8 by using the honeycomb structure body molding die 1 of the structure discussed above is described below in detail.

First, the honeycomb structure body molding die 1 is attached to a screw type extrusion molding machine (not shown) at a distal end thereof. Then, a kneaded ceramic raw material is supplied into the extrusion molding machine. Examples of the ceramic raw material include a cordierite yielding raw molding material powder containing kaolin, fused silica, aluminum hydroxide, alumina and talc, which are blended to finally form a chemical composition of cordierite as a principal component. The cordierite yielding raw material powder is further mixed with water, a binder and pore forming materials or the like, upon which a resulting mixture is kneaded.

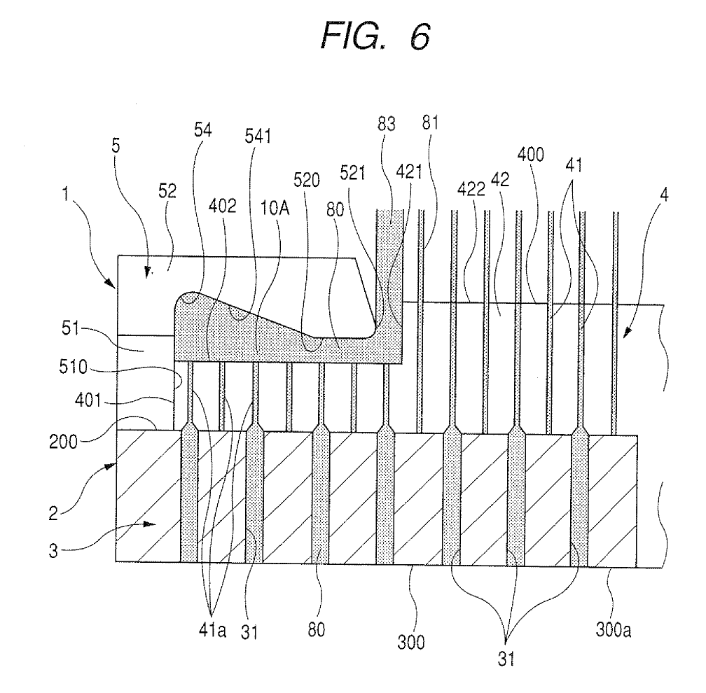

As shown in FIG. 6, next, the screw type extrusion molding machine operates to feed the molding material 80 into the material feed bores 31 of the honeycomb structure body molding die 1.

Of the molding material 80 fed into the material feed bores 31, components of the molding material 80, squeezed from slit recesses 41a opening in positions facing the opposing guide surface 520 (especially the pool recess 54), pass through the clearance 10 to be pooled in the pool recess 54 once. Then, the molding material 80, pooled in the pool recess 54 once, passes through the clearance 10 again to move in the die main body 2 toward the center thereof. When this takes place, the pool recess slanted surface 541 acts to progressively pressurize the molding material 80, thereby enabling an increase in density of the molding material 80. Thereafter, the molding material 80 goes through the clearance 10 to move radially inward toward a center of the stepped section 42 of the die main body 2. Then, the molding material 80 is brought into abutting engagement with the outer circumferential sidewall 421 of the stepped section 42 to be bent at a right angle in an area between the radially inward guide end 521 of the guide ring 5 and the outer circumferential sidewall 421 of the stepped section 42. This results in the formation of the outer circumferential skin 83 of the honeycomb structure body.

Further, simultaneously, the molding material 80 is admitted to the material feed bores 31 associated with a central feed bore forming region 300a to be squeezed through the slit recesses 41 exposed to the central slit recess forming surface 422, thereby directly forming the cell walls 81 in a squared lattice pattern.

Thus, the outer circumferential skin 83 and the cell walls 81 are integrally formed in a conincidental development, thereby forming the honeycomb structure body 8 having the honeycomb-shaped cell walls 81, the large number of cells 82 surrounded with the cell walls 81, respectively, and the outer circumferential skin 83 covering an outer circumferential sidewall of the honeycomb structure body 8.

In addition, the honeycomb structure body 8, formed upon extrusion process, is dried and fired at a given temperature, thereby preparing the honeycomb structure body 8 composed of cordierite ceramics.

Next, description is made of various advantageous effects of the honeycomb structure body molding die 1 of the present embodiment.

With the honeycomb structure body molding die 1 of the present embodiment, the guide section 52 of the guide ring 5 has the overall circumferential area formed with the annular pool recess 54 concaved from the opposing guide surface 520 in the extruding direction so as to face the outer circumferential slit recess forming surface 402 of the slit recess section 4 of the die main body 2. Therefore, the molding material 80, passed through the slit recesses 41a to be squeezed therefrom to the clearance 10, flows into the pool recess 54 once to be pooled therein. Thereafter, the molding material 80 moves through the clearance 10 toward the center of the die main body 2. Then, the molding material 80 is brought into contact with the outer circumferential sidewall 421 of the slit recess section 4 to turn in the extruding direction along an axial direction of the die main body 2, thereby forming the outer circumferential skin 83.

That is, the squeezed molding material 80 is accumulated once in the pool recess 54 and caused to move toward the center of the die main body 2. This enables the molding die 80 to move toward the center of the die main body 2 in uniformalized flow states (in flow, flow speed and flow direction of the molding material 80). This results in a reduction in variation of a thickness of the outer circumferential skin 83 during the molding process of the honeycomb structure body 8. This allows the honeycomb structure body 8 to have the outer circumferential skin 83 with excellent moldability and uniformity.

In the illustrated embodiment, further, the annular pool recess 54 has the inner circumferential surface formed with the pool recess slanted surface 541 that is tapered so as to decrease in axial depth as the inner end of the pool recess slanted surface 541 approaches the guide end 521 of the guide section 52. Thus, the pool recess slanted surface 541 is slanted at the inclining angle β satisfying the relationship expressed as 10°≦β≦20°. Thus, with the pool recess 54 formed with the pool recess slanted surface 541 slanted at the inclining angle β defined in such a specified angle, the molding material 80 is caused to move from the pool recess 54 to pass through the clearance 10 toward the center of the die main body 2, during which the molding material 80 is progressively pressurized with an action of the pool recess slanted surface 541. This results in an increase in density of the molding material 80, causing the molding material 80 with increased density to move toward the center of the die main body 2. Thus, the molding material 80 with increased density enables the outer circumferential skin 83 to be formed with increased precision.

Thus, the honeycomb structure molding die 1 of the present embodiment can mold the honeycomb structure body 8 having the outer circumferential skin 83 with increased precision.

### Second Embodiment

A honeycomb structure molding die 1A of a second embodiment according to the present invention is described below in detail.

The honeycomb structure molding die 1A of the present embodiment differs from the honeycomb structure molding die 1 of the first embodiment in that a slit recess section 4A includes a coplanar slit recess forming surface 400A in the absence of the stepped section 42.

The honeycomb structure molding die 1A of the present embodiment has a different structure to that of the honeycomb structure molding die 1 of the first embodiment with the same advantageous effects as those discussed above.

### Third Embodiment

A honeycomb structure molding die 1B of a third embodiment according to the present invention is described below in detail.

The honeycomb structure molding die 1B of the present embodiment differs from the honeycomb structure molding die 1 of the first embodiment in respect of a die main body 2A and, therefore, description will be made with a focus on such a differing point.

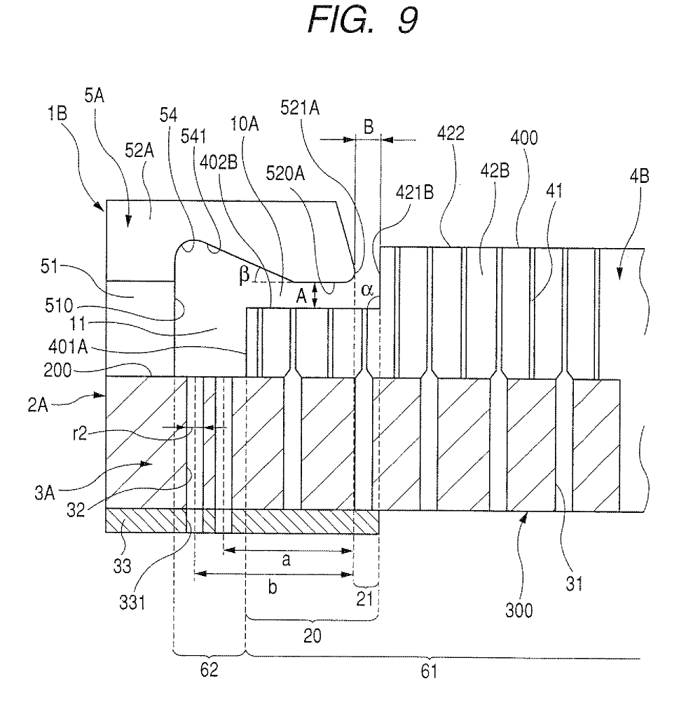

As shown in FIG. 9, with the honeycomb structure molding die 1B of the present embodiment, the die main body 2A has a central slit recess forming region 61, covering an area having the slit recesses 41 formed in the slit recess forming surface 400 and an outer circumferential slit recess forming surface 402B, and an outer circumferential skin forming feed-bore forming region 62 formed in an area outside of the central slit recess forming region 61. The outer circumferential skin forming feed-bore forming region 62 takes the form of an annular shape extending so as to surround the central slit recess forming region 61 in a radially inward position.

The outer circumferential skin forming feed-bore forming region 62 has a plurality of outer circumferential skin forming material feed bores 32, which extend through a die main body 2A to feed the molding material to form the outer circumferential skin 83. The plural outer circumferential skin forming material feed bores 32 are formed in two annular rows in the outer circumferential skin forming feed-bore forming region 62. Each of the plural outer circumferential skin forming material feed bores 32 has an inner diameter r2 of 1.5 mm.

Further, in each row of the outer circumferential skin forming material feed bores 32, the outer circumferential skin forming material feed bores 32 are located in positions remote from the radially inward guide end 521A of the guide section 5A with the same distance therefrom. In the illustrated embodiment shown in FIG. 9, a minimal distance “a” between the center of each bore 32 of a first row and the radially inward guide end 521A of the guide section 5A is set to 7 mm. A minimal distance “b” between the center of each bore 32 of a second row and the radially inward guide end 521 of the guide section 5A is set to 10 mm.

Furthermore, the die main body 2A has an outer-circumferential-skin molding material feed passage 11 formed in an area between the inner circumferential surface 510 of the upright support section 51 and an outer circumferential sidewall 401A of a slit recess section 4B.

As shown in FIG. 9, with the present embodiment, a stepped section 42B is formed with an outer circumferential sidewall 421B and the outer circumferential slit recess forming surface 402B so as to intersect at an angle α expressed as 90°≦α≦95°. In the illustrated embodiment, the angle α is set to 90°.

Further, the guide section 52A has an opposing guide surface 520A axially spaced from the outer circumferential slit recess surface 402B by a distance A and has a radially inward guide end 521A radially spaced from the outer circumferential sidewall 421B of the stepped section 42B by a distance B on a plane perpendicular to a traveling direction of the molding material. The distances A and B satisfy the relationship expressed as A≦B<1.5 A. In the illustrated embodiment, the distance A is set to 0.4 mm and the distance B is set to 0.55 mm.

As shown in FIG. 9, furthermore, the die main body 2 has a feed bore closing region 20 that closes the material feed bores 31 to disable the supply of molding material therethrough. The feed bore closing region 20 includes a region involving a non-opposed region 21, defined between the radially inward guide end 521A and the outer circumferential sidewall 421B, in which no outer circumferential slit recess forming surface 402B faces the guide section 52A.

With the present embodiment, the feed bore closing region 20 is formed by placing a ring-shaped molding material blocking member 33, taking the form of an annular ring, on a given specified area of the feed bore forming surface 300 to prevent the entry of molding material 80 to the material feed bores 31 present in the feed bore closing region 21. The molding material blocking member 33 has a structure to close all of the feed bores 31 held in communication with the slit recesses 41 exposed to the outer circumferential slit recess surface 402B. That is, the molding material blocking member 33 closes all of the feed bores 31 located in the feed bore closing region in a position radially outside of the stepped section 42B. Moreover, the molding material blocking member 33 has first and second rows of communication bores 331 held in communication with the outer circumferential skin forming material feed bores 32, respectively.

The manufacturing method of the third embodiment has the other same steps as those of the first embodiment.

Next, a method of manufacturing the honeycomb structure body 8 by using the honeycomb structure molding die 1B of the third embodiment shown in FIG. 9 will be simply described below.

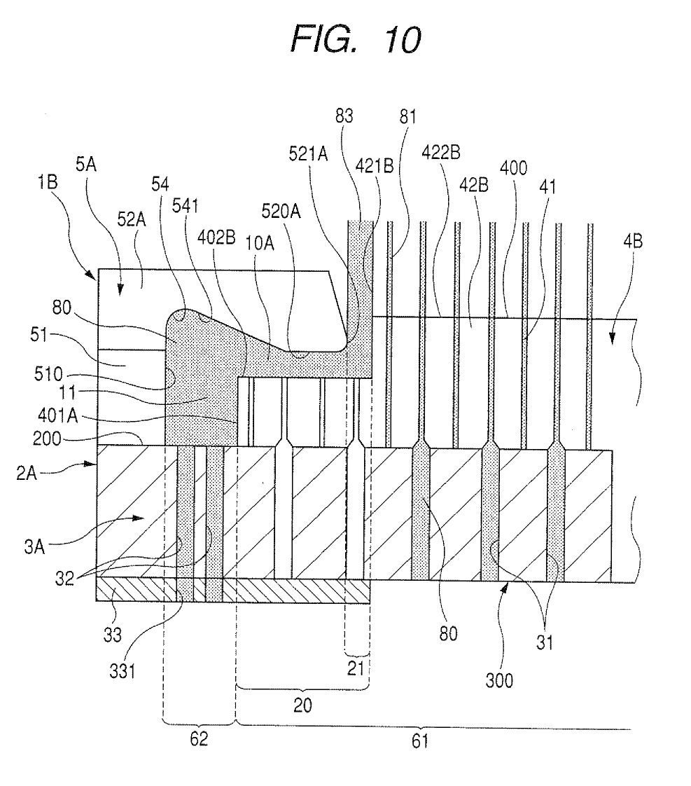

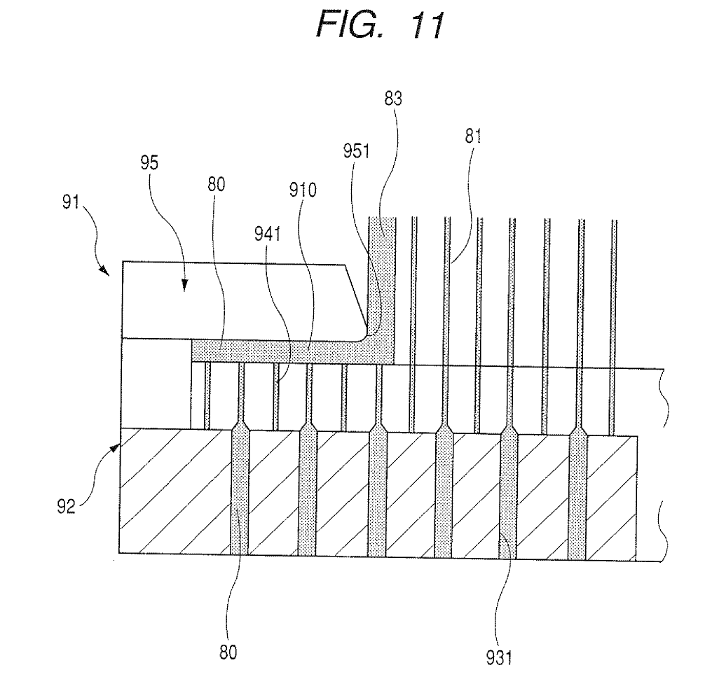

As shown in FIG. 10, first, the molding material 80 is supplied to the material feed bores 31 and the outer circumferential skin forming material feed bores 32. In this case, no molding material 80 is admitted to the material feed bores 31 blocked with the molding material blocking member 33.

The molding material 80, admitted to the outer circumferential skin forming material feed bores 32, is squeezed from the reference surface 200 of the die main body 2A into the outer-circumferential-skin molding material feed passage 11. Then, the molding material 80 flows into a clearance 10A between the outer circumferential slit recess forming surface 402B and the opposing guide surface 520A of the guide section 52A to accumulate in the pool recess 54 once. Thereafter, the molding material 80 further flows from the pool recess 54 into the clearance 10A again to pass toward the center of the die main body 2A. Then, the molding material 80 is guided with the guide section 52A to turn in the extruding direction by the action of the outer circumferential sidewall 421B of the stepped section 42B, thereby forming the outer circumferential skin 83.

Further, the molding material 80, admitted to the material feed bores 31 and the slit recesses 41 in communication therewith, is squeezed from a central slit recess forming surface 422B of the stepped section 42B, thereby directly forming the square-lattice-shaped cell walls 81.

The manufacturing method of the present embodiment has the other same steps as those of the manufacturing method of the first embodiment.

The honeycomb structure body molding die of the present embodiment has advantageous effects as described below.

With the honeycomb structure body molding die 1B of the present embodiment, the die main body 2A has the outer circumferential skin forming feed-bore forming region 62 placed in the area outside of the slit recess forming region 61 so as to surround the same. The outer circumferential skin forming feed-bore forming region 62 has the outer circumferential skin forming bores 32 formed in plural annular rows to supply the molding material 80 for forming the outer circumferential skin 83. That is, the honeycomb structure body molding die 1B of the present embodiment takes the form of a structure adapted to supply the molding material 80 only through the outer circumferential skin forming bores 32 formed in the outer circumferential skin forming feed-bore forming region 62 placed in the area outside of the slit recess forming region 61.

With the present embodiment, the outer circumferential skin forming material feed bores 32 formed in the first circular row are distanced from the radially inward guide end 521A of the guide section 52A in a direction perpendicular to the squeezing direction by an equal length corresponding to a distance “a”. Likewise, the outer circumferential skin forming material feed bores 32 on the second circular row are distanced from the radially inward guide end 521A of the guide section 52A in the direction perpendicular to the squeezing direction by an equal length corresponding to a distance “b”. During a process in which the honeycomb structure body 8 is formed, therefore, the material 80 squeezed from the outer circumferential skin forming material feed bores 32 of the first and second rows present in the outer circumferential skin forming feed-bore forming region 62 travels in a nearly equal length in each row to reach the radially inward guide end 521A of the guide section 52A. Then, the radially inward guide end 521A of the guide section 52A turns a front end of the molding material 80 in the extruding direction, thereby forming the outer circumferential skin 83. That is, the material 80, supplied from the outer circumferential skin forming feed-bore forming region 62 for the formation of the outer circumferential skin 83, can be maintained in a nearly fixed volume. This enables the suppression of variation in the material 80 to be supplied for the outer circumferential skin 83 to be formed, thereby enabling the formation of the outer circumferential skin 83 with uniform thickness.

Further, the die main body 2 has the stepped section 42B that protrudes in the extruding direction as mentioned above. The stepped section 42B has the outer circumferential sidewall 421B extending from the outer circumferential slit recess forming surface 402B at an angle a satisfying the relationship expressed as 90°≦α≦95°. Therefore, during a travel of the material 80 to turn in the extruding direction in an area near the radially inward guide end 521A of the guide section 52A, the stepped section 42B is able to restrict further inward movement of the material 80 to the center of the die main body 2A, while insuring the material 80 to turn in the extruding direction. This enables the outer circumferential skin 83 to be formed in the extruding direction, while preventing the outer circumferential skin 83 and the cell walls 81, adjacent to the outer circumferential skin 83, from collapsing.

With the present embodiment, further, the relationship is established as A≦B<1.5 A wherein A represents the distance between the outer circumferential slit recess forming surface 402B and the guide section 52A and B represents the distance between the outer circumferential sidewall 421B and the radially inward guide end 521A of the guide section 52A along the direction perpendicular to the extruding direction of the material 80. The outer circumferential skin 83 is formed by the material 80 passing through the clearance 10A in the form of a thickness of the distance A and passing through an area between the outer circumferential sidewall 421B of the stepped section 42B and the radially inward guide end 521A of the guide section 52A. This allows the thickness of the resulting outer circumferential skin 83 to be determined. With the distances A and B satisfying the relationship discussed above, the molding material 80 for forming the outer circumferential skin 83 can be almost covered with the molding material supplied through the clearance 10A between the outer circumferential slit recess forming surface 402B of the stepped section 42B and the guide section 52A. This enables the outer circumferential skin 83 to have a desired thickness in a stable manner with no occurrence of a fear of a shortage in the amount of supply of the material 80 forming the outer circumferential skin 83.

With the present embodiment, furthermore, furthermore, the die main body 2A has the feed bore closing region 20 that closes the material feed bores 31 to disable the supply of molding material therethrough. The feed bore closing region 20 includes the region involving at least the non-opposed region 21, defined between the radially inward guide end 521A and the outer circumferential sidewall 421B, in which no outer circumferential slit recess forming surface 402B faces the guide section 52A in the extruding direction. This precludes the molding material 80 from being supplied from the feed bores 31 present in the non-opposed region 21 during the process in which the honeycomb structure body 8 is formed. Thus, no molding material is squeezed from the slit recesses 41 communicating with the relevant feed bores 31 present in the non-opposed region 21, thereby avoiding an adverse affect on the formation of the outer circumferential skin 83.

That is, with the present embodiment, the honeycomb structure body 8 is molded such that only the molding material 80, delivered through the clearance 10A between the die main body 2A and the guide section 52A, is used to form the outer circumferential skin 83 to be obtained. More particularly, the molding material 80, squeezed from the outer circumferential skin forming material feed bores 32 provided in an area outside of the feed bore closing region to the clearance 10A, flows through the clearance 10A toward the center of the die main body 2A. Then, the guide section 52A guides the molding member 80 at the guide end 521A of the guide section 52. During such flowing movement, the stepped section 42B restricts the further inward movement of the molding material 80 toward the center of the die main body 2A to turn the molding material 80 in the extruding direction, thereby forming the outer circumferential skin 83. Therefore, the outer circumferential skin 83 can be formed of only the molding material 80 flowing in the same direction. This allows the outer circumferential skin 83 to be formed with high precision in a stable fashion. Thus, it becomes possible to suppress the occurrence of defects such as thickness nonuniformity and deterioration in strength or the like.

The present embodiment has the other advantageous effects as those of the first embodiment.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A honeycomb structure body molding die for molding a honeycomb structure body having honeycomb-shaped cells walls, a large number of cells surrounded with the cells walls, and a cylindrical outer circumferential skin covering an outer circumferential sidewall, wherein the cell walls and the outer circumferential skin are unitarily formed, the honeycomb structure body molding die comprising:
a die main body having material feed bores, through which a molding material is fed, and lattice-shaped slit recesses formed in communication with the material feed bores, respectively, for forming the molding material into a honeycomb configuration; and
a guide ring having an upright support section extending from the die main body in an extruding direction of the molding material, and a guide section protruding inward from the upright support section with a clearance spaced from the die main body;
wherein the guide section of the guide ring has an opposing guide surface, facing a slit recess forming surface of the die main body, which has an annular circumferential area formed with a pool recess concaved from the opposing guide surface in the extruding direction; and
wherein the pool recess has an inner surface formed with a pool recess slanted surface that is tapered with respect to the opposing guide surface at an inclining angle β satisfying the relationship expressed as 10°≦β≦20° so as to decrease in depth as an inner radial end of the pool recess slanted surface approaches the guide end of the guide section.

2. The honeycomb structure body molding die according to claim 1, wherein:
the inner radial end of the pool recess slanted surface is spaced from the guide end of the guide section on a plane perpendicular to the extruding direction by a distance ranging from 0.5 to 20 mm.

3. The honeycomb structure body molding die according to claim 1, wherein:
the slit recess forming surface of the die main body is formed on a coplanar plane.

4. The honeycomb structure body molding die according to claim 1, wherein:
the die main body comprises a stepped section protruding from the slit recess forming surface in the extruding direction in an area where the stepped section does not oppose the guide section in an axial direction of the die main body.

5. The honeycomb structure body molding die according to claim 1, wherein:
the slit recess section has an outer circumferential sidewall radially held in contact with the upright support section of the guide ring; and
the slit recess forming section includes a central slit recess forming surface and an outer circumferential slit recess forming surface formed around the central slit recess forming surface.

6. The honeycomb structure body molding die according to claim 1, wherein:
the slit recess section has an outer circumferential sidewall radially held in contact with the upright support section of the guide ring; and
the slit recess forming section includes a slit recess forming surface formed over a whole area on a coplanar plane.

7. The honeycomb structure body molding die according to claim 5, wherein:
the slit recess section has an outer circumferential sidewall radially spaced from the upright support section of the guide ring to define an outer-circumferential-skin molding material feed passage to allow the molding material to flow into the pool recess.

8. The honeycomb structure body molding die according to claim 7, further comprising:
an annular molding material blocking member placed on one surface of the die main body to block the feed bores in a feed bore closing region to prevent the molding material from being supplied into the clearance between the guide ring and the die main body in the feed bore closing region while permitting the supply of the molding material into the outer-circumferential-skin molding material feed passage.

9. The honeycomb structure body molding die according to claim 7, wherein:
the die main body has an outer circumferential skin forming feed-bore forming region formed with a plurality of outer circumferential skin forming material feed bores arrayed on a common circular row.
